(19) United States
(12) Patent Application Publication
(10) Pub. No.: US 2025/0124631 A1
(43) Pub. Date: Apr. 17, 2025

(54) FITTING THREE-DIMENSIONAL DIGITAL ITEMS TO CHARACTER MODELS USING MACHINE LEARNING

(71) Applicant: Blizzard Entertainment, Inc., Irvine, CA (US)

(72) Inventors: Xingyu Liu, Costa Mesa, CA (US); James Steven Supancic, III, Irvine, CA (US); Sam Fung, Tustin, CA (US); Ehsan Sayyad, Goleta, CA (US); Wayne Yang, Lake Forest, CA (US)

(21) Appl. No.: 18/380,048

(22) Filed: Oct. 13, 2023

(51) Int. Cl. G06T 13/40; G06T 7/50; G06T 17/20

(52) U.S. Cl. CPC G06T 13/40; G06T 7/50; G06T 17/205; G06T 2207/20081

(57) ABSTRACT

Systems and methods for modifying three-dimensional digital items to fit different character models are described herein. A machine learning system may be configured to compute a shape and a size of three-dimensional digital objects fit for a second character model based on a shape and a size of the three-dimensional digital objects fit for a first character model. Using the machine learning system, a base transform matrix may be generated, which corresponds to a first exemplary three-dimensional digital object fit for the first character model and a second exemplary three-dimensional digital object fit for the second character model. The machine learning system may be trained using the base transform matrix and machine-learning training data. Input data may be received from a client computing device, where the input data defines a plurality of input vertices for an input three-dimensional digital object fit for the first character model. Using the machine learning system, output data may be generated that defines a plurality of output vertices for an output three-dimensional digital object for the second character model.

### FIELD OF THE INVENTION

The present disclosure relates to three-dimensional digital animation. Specifically, the present disclosure relates to machine learning systems used to change a shape of a three-dimensional digital item to fit one or more character models.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Video games, animated movies, and other media rely on a large amount of digital modeling. While each frame could be generated as a still image, doing so at any scale would be extremely inefficient and, in many cases, completely untenable. Instead, artists tend to create digital models of characters and digital models of different items that a character might wear. For instance, a lab coat may be modeled separate from a character and then set on the character at a later stage in the animation process.

As a media project becomes larger, the number of items to model becomes larger. This problem of scope is exacerbated when it comes to interactive media, such as video games, where individual items may need to be modeled multiple times to fit different characters. For example, in one online game, over a thousand armor pieces have been modeled to fit thirty-six unique character models, ranging from male humans to female panda-like creatures called pandaren.

With larger scope projects, every addition to the project takes on an increasing level of scale. For instance, each new armor piece added to the online game discussed above has to be modeled thirty-six times while each new character model added may require many existing armor pieces to need to be adjusted to fit the new character model. The increasing technical cost of adding character models and armor pieces can increase the amount of time it takes to update a project and can have a chilling effect on creativity. Artists are discouraged from creating new character models with radically different features, as any new character model with radically different features will be more difficult to fit into existing armor pieces than a character model that is similar to an existing character model.

On the other hand, the automated fitting of digital items for new character models may also stifle creativity and create other new issues. While automated fitting systems may decrease the time needed to implement new digital items for various character models, such systems may be unable to account for artistic traits that are specific to individual character models. In addition, automated fitting systems may not be equally suited to fit every type of digital item. While helmets may largely retain similar shapes and symmetries when fit for different character models, leg armor pieces designed for humanoid character models may greatly differ from those designed for zoomorphic character models. Similarly, digital items that are automatically fit for structurally diverse character models may suffer from issues with symmetries that are not preserved when fit for new character models, issues with unintended clipping of digital items into character models, and other problems. The time needed to fix these issues each time a digital item is fit for a new character model can defeat the purpose of automated fitting systems.

Thus, there is a need for a system that can fit digital items for different character models that is capable of fitting various different types of digital items, that incorporates the distinct characteristics of individual character models, and that automatically fixes symmetry and clipping issues.

### BRIEF DESCRIPTION OF THE DRAWINGS

In the drawings:

FIG. 1 depicts an example system for modifying three-dimensional digital objects to fit different character models.

FIG. 2 depicts an example method of training and utilizing a machine learning system configured to compute a shape and size of three-dimensional digital objects to fit a second character model based on the shape and size that the same three-dimensional digital objects have to fit a first character model.

FIG. 3 depicts an example method for performing vertex matching for digital items scaled to different character models.

FIG. 4 is a flow chart that depicts an example method for repairing clipped vertices in three-dimensional digital objects fit to character models.

FIG. 5 is a flow chart that depicts an example method for enforcing local symmetry within three-dimensional digital objects.

FIG. 6 depicts an example interface presenting a character model combined with an output three-dimensional digital item.

FIG. 7 is a block diagram that illustrates a computer system upon which an implementation may be implemented.

### DETAILED DESCRIPTION

In the following description, for the purposes of explanation, numerous specific details are set forth in order to provide a thorough understanding of the present disclosure. It will be apparent, however, that implementations may be practiced without these specific details. In other instances, well-known structures and devices are shown in block diagram form in order to avoid unnecessarily obscuring the present disclosure.

### General Overview

Systems and methods for modifying three-dimensional digital items to fit different character models are described herein. According to an implementation, a system stores data defining a plurality of different three-dimensional digital items, such as armor or clothing pieces, fit to a plurality of character models, such as character models corresponding to different genders and fictional races.

The system matches vertices of the different model-specific, three-dimensional digital items fit to a first character model with vertices of the different model-specific, three-dimensional digital items fit to a second character model.

As used herein, a “base transform” refers to a particular transform of (a) the set of model-specific vertices for a particular category of digital item fit to the first character model, to (b) the set of model-specific vertices for that particular category of digital item fit to the second character model. That is, a base transform can represent one three-dimensional digital item that has been manually fit for the second character model; the base transform incorporates one or more characteristics of the three-dimensional digital item when fit to the second character model that may not be present when fit to the first character model.

In one implementation, the system obtains a training dataset. The training dataset includes training examples. Each training example includes one set of model-specific vertices (of an item fit for the first character model) and a second set of model-specific vertices (of the same item fit for the second character model). Some or all of the training examples may correspond to base transforms. Using the training dataset, a machine learning system is then trained to transform items fit for the first character model to items fit for the second character model.

When the system receives data defining a new three-dimensional digital item fit to the first character model, the system computes output vertices using the trained machine learning system to generate a version of the new three-dimensional digital item fit to the second character model. The system further applies one or more post-processing techniques to these output vertices to generate new output vertices representing a post-processed version of the new three-dimensional digital item fit to the second character model. These post-processing techniques can include, for example, enforcement of local symmetries within the new three-dimensional digital item, correction of unintended clipping of portion(s) of the new three-dimensional digital item into the second character model, or other techniques.

### Structural Overview

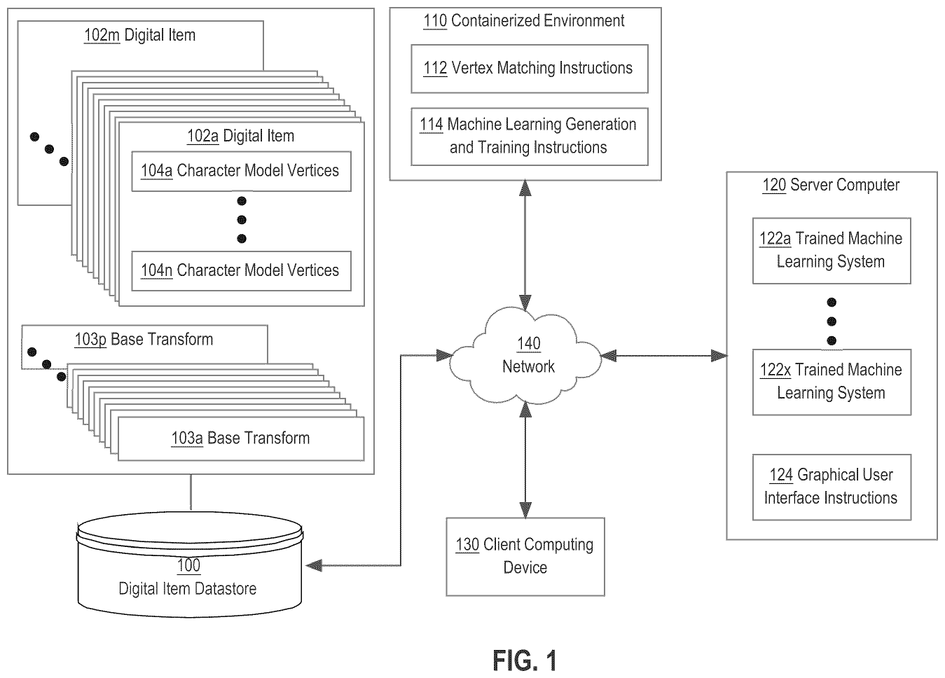

FIG. 1 depicts an example system for modifying three-dimensional digital objects to fit different character models.

Digital item data store 100, containerized environment 110, server computer 120, and client computing device 130 can be communicatively coupled over a network 140. Network 140 can broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. The digital item data store 100, containerized environment 110, server computer 120, client computing device 130, and other elements of the system each can comprise an interface compatible with the network 140 and are programmed or configured to use standardized protocols for communication across the networks such as TCP/IP, Bluetooth, CAN protocol and higher-layer protocols such as HTTP, TLS, and the like.

Digital item data store 100 comprises a storage medium configured to store data relating to a plurality of digital items. Digital item data store 100 may comprise a database. As used herein, the term “database” may refer to either a body of data stored in a repository, the repository itself (e.g., a relational database management system (RDBMS)), or to both. As used herein, a database may comprise any collection of data including hierarchical databases, relational databases, flat file databases, object-relational databases, object-oriented databases, distributed databases, and any other structured collection of records or data that is stored in a computer system. The techniques described herein are not limited to any particular database system.

In an implementation, digital item data store 100 stores digital items 102a-102m and base transforms 103a-103p. Each of digital items 102a-102m comprise data defining three-dimensional model-specific digital items. As an example, digital items 102a-102m may comprise three-dimensional cosmetic items designed to be fit to character models for three-dimensional rendering. The digital items 102a-102m may be defined based on a size and shape of the digital items, such as through vertices on a three-dimensional mesh. The digital items 102a-102m may be further defined with other information, such as data defining textures, colors, physical properties such as material, moveability, or environmental interactions, lighting, and/or any other characteristics. When the term “digital item” is used herein, it may refer to either a single three-dimensional item (e.g., a helm) or to a pair of complementary three-dimensional items (e.g., a matching set of greaves).

In an implementation, each of the digital items 102a-102m may be classified into one of a plurality of categories of digital items. The plurality of categories may be based on, for instance, the different portions of a character model for which the digital items 102a-102m may be fit. As an example, some of the digital items 102a-102m fit for a head portion of a character model may be classified in a category of helms, while other digital items 102a-102m fit for hand portions of a character model may be classified in a category of gauntlets. These categories may be further subdivided based on the particular character model for which the associated digital items 102a-102m are fit, such as, for example, gauntlets fit for human males or gauntlets fit for female worgen.

Each of the digital items 102a-102m may be fit to a plurality of character models. For example, a particular spiked helmet may have a different representation when fit to a human character model than when fit to a pandaren character model. In an implementation, each digital item of digital items 102a-102m includes character model vertices 104a-104n. Each of character model vertices 104a-104n of a digital item 102a comprise data defining vertices for a model-specific version of the digital item 102a (i.e. the digital item 102a when fit to a particular character model). For example, character model vertices 104a may comprise vertices for the particular spiked helmet when fit to a male human character model, while character model vertices 104n may comprise vertices for the particular spiked helmet when fit to a female pandaren character model. The vertices may be defined by coordinates in three-dimensional space and/or by the vertices to which they connect.

Digital item data store 100 thus stores (m) digital items fit to (n) different character models. Thus, digital item data store 100 stores vertices for m*n model-specific three-dimensional digital objects. For instance, if digital item data store 100 stores data for 500 different helmets fit to 20-character models, digital item data store 100 may store data defining vertices for 10,000 model-specific three-dimensional items. While digital items 102a-102m are depicted as being uniform, some digital items may lack data for different character models. For example, a particular helmet may be fit to only a subset of the character models, either by design or because a fit to other character models has not been performed.

Each of the base transforms 103a-103p may represent a transformation of a first digital item 102a fit for a first character model to a second digital item 102b fit for a second character model. Each of the base transforms 103a-103p may include a three-dimensional transformation of individual vertices of the first digital item 102a fit for the first character model to corresponding individual vertices of the second digital item 102b fit for the second character model. Each base transform 103a-103p may represent a three-dimensional transformation such as, for example, translation, rotation, scale, shear, or other three-dimensional transformation. A first digital item 102a and second digital item 102b associated with one of the base transforms 103a-103p may be three-dimensional digital items created by an artist or other person and manually fit to the first character model and second character model, respectively. By manually fitting the second digital item 102b, an artist may allow the second digital item 102b to capture one or more characteristics specific to the second character model (e.g., the large size of armor fit for an orc character model) or specific to a particular portion of the second character model (e.g., the segmentation of a cuisse fit for a draenei due to the reverse flexion of their legs). For example, the second digital item 102b can capture the location and positioning of a vambrace on the forearm of an orc character model, which may be different from the location and positioning of a vambrace on the forearm of a human character model. Each of the (n) character models represented by the character model vertices 104a may be associated with one or more base transforms 103a-103p, each of which may represent a different artistic interpretation of characteristics of digital that are specific to the corresponding character model and/or a particular portion of that character model. In some implementations, a particular one of the base transforms 103a-103b can represent an approximate three-dimensional transform of a category of similar digital items from a first character model to a second character model (e.g., for cuirasses fit for Tauren in general).

Containerized environment 110 comprises a computer system, such as a server computer, that hosts one or more container environments, such as Docker or Kubernetes containers. The container environment may comprise a stand-alone executable software package that provides particular services and includes everything need to run the software package, including code, runtime, system libraries, settings, etc. The container environments may implement a Container Network Interface (CNI) networking model or a Container Network Model (CNM) adopted by popular container orchestrators to perform local programming. While FIG. 1 depicts the model training being performed in a containerized environment 110 to provide a clear example, other implementations may include physical computing devices training the model. Additionally, other computing devices described in FIG. 1 may be implemented through a containerized environment in other implementations.

In an implementation, containerized environment 110 comprises vertex matching instructions 112. Vertex matching instructions 112 comprise computer-readable instructions which, when executed, cause a computing system hosting containerized environment 110 to perform the vertex matching methods described further herein. While vertex matching instructions 112 are depicted as being stored and executed in containerized environment 110, in other implementations the vertex matching methods may be performed in a different computing device and containerized environment 110 may receive the outputs of the vertex matching, such as training datasets with matched vertices.

Machine learning generation and training instructions 114 comprise computer-readable instructions which, when executed, cause a computing system hosting containerized environment 110 to initialize and/or train one or more machine learning models. Machine learning generation and training instructions 114 may define one or more of a type of model to be initialized, parameters for the model, equations for the model, input types for the model, output types for the model, and/or instructions for training the model using training datasets as described herein. For example, the machine learning generation and training instructions 114 may define a regression model according to a particular linear equation which is configured to compute a shape and size of three-dimensional digital objects to fit a first character model based on the shape and size that the same three-dimensional digital objects have to fit a second character model, and based on a base transform 103 corresponding to the first character model and the second character model.

Server computer 120 may be implemented using a server-class computer or other computers having one or more processor cores, co-processors, or other computers. Server computer 120 may be a physical server computer and/or a virtual server instance stored in a data center, such as through cloud computing. Server computer 120 may store trained machine learning systems 122a-122n and graphical user interface instructions 124. Server computer 120 may be configured to receive input data from a client computing device 130, use one or more trained machine learning systems to compute one or more outputs, and provide the one or more outputs to the client computing device 130.

Trained machine learning systems 122a-122x comprise machine learning systems configured to compute a shape and size of model-specific three-dimensional digital objects to fit a second character model based on the shape and size that the same three-dimensional digital objects have to fit a first character model, and on a base transform 103 corresponding to the first character model and second character model. Server computer 120 may receive the trained machine learning systems 122a-122x from the containerized environment 110.

The number of machine learning systems (x) may correspond to a number of character models (n) for which vertex information is stored for the digital items stored in digital item datastore 100. For example, in an implementation where the machine learning systems all translate from a particular source character model (e.g., a male human model) as inputs to different character models (e.g., elves, pandarans, etc.) as outputs, the number of machine learning systems may comprise x=n−1, as there would be one machine learning system for each character model except the source character model, plus one machine learning system for each character model that excludes the base transforms 103a-103p. As another example, in implementations where any character model can be used as a source character model, the number of machine learning systems may be x=n(n−1). For instance, the first described example may allow computation of shapes and sizes of different model-specific versions of a digital item that is originally fit to a male human while the second described example may allow computation of shapes and sizes of different model-specific versions of a digital item regardless of the character model to which it is originally fit.

Graphical user interface instructions 124 comprise computer readable instructions which, when executed by the server computer 120 cause the server computer to generate and cause display, through a graphical user interface on client computing device 130, output digital items. The output digital items may be displayed with character models to which they are fit. For example, a helmet fit to a female goblin character may be displayed being worn by a female goblin character model. The graphical user interface may be generated by the server computer 120 and/or by the client computing device 130.

The client computing device 130 is a computer that includes hardware capable of communicatively coupling the device to one or more server computer, such as server computer 120, over one or more service provides. For example, client computing device 130 may include a network card that communicates with server computer 120 through a home or office wireless router (not illustrated in FIG. 1) coupled to an internet service provider. The client computing device 130 may be a smart phone, personal computer, tabled computing device, PDA, laptop, or any other computing device capable of transmitting and receiving information and performing the functions described herein.

For purposes of illustrating a clear example, FIG. 1 shows a limited number of instances of certain functional elements. However, in other implementations, there may be any number of such elements. For example, server computer 120 may receive requests from any number of client computing devices 130. Further, the server computer 120 may be implemented using two or more processor cores, clusters, or instances of physical machines or virtual machines, configured in a discreet location or co-located with other elements in a datacenter, share computing facility, or cloud computing facility. In other implementations, one or more of the elements depicted herein may be combined. For example, a server computing device may store the trained machine learning systems. As another example, a same server computer may perform the training of the machine learning system and the computation of outputs using the trained machine learning system.

### Functional Overview

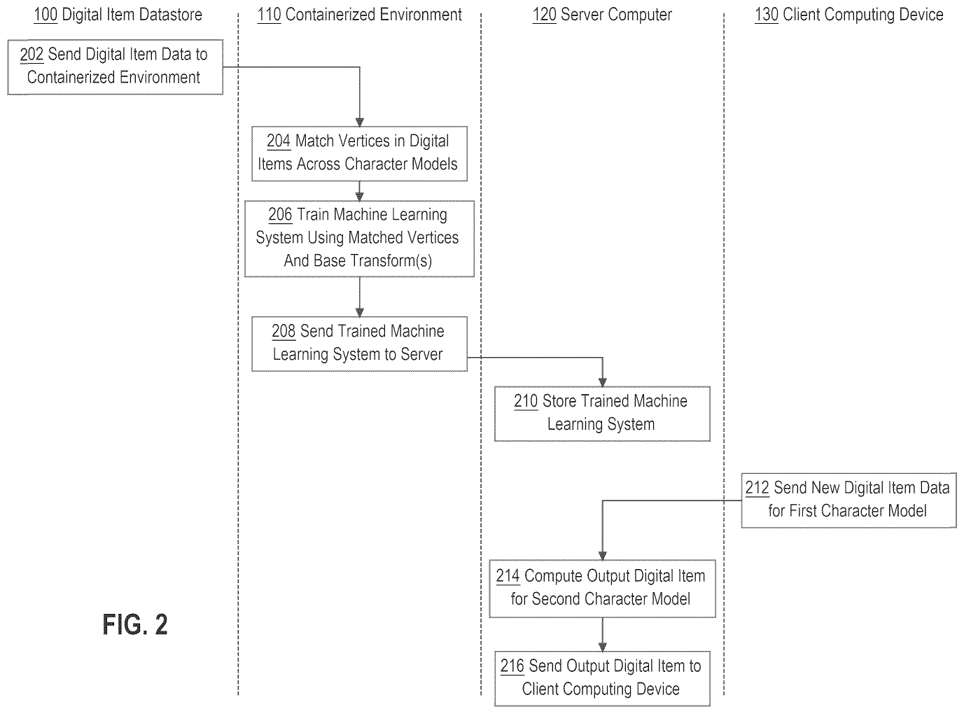

FIG. 2 depicts an example method of training and utilizing a machine learning system configured to compute a shape and size of a model-specific digital object for a second character model (e.g. a pair of pauldrons for a female dwarf) based on the shape and size of a model-specific digital object, for the same digital object, fit to a first character model (e.g. a pair of pauldrons for a male human) and based on a base transform for a category of digital objects associated with the same digital item, from the first character model to the second character model (e.g., for pauldrons fit to a male human to pauldrons fit to a female dwarf).

At step 202, digital item data is sent from digital item data store 100 to containerized environment 110. For example, digital item data store 100 may store data defining a plurality of digital items, each of which fit to a plurality of different character models, including a first character model and a second character model. As another example, the digital item data store 100 may store data defining a plurality of base transforms corresponding various categories of digital items and the plurality of different character models. The digital item data store 100 may send the data defining the plurality of digital items to the containerized environment 110. Additionally or alternatively, the data sent to containerized environment 110 may comprise a subset of the stored data that defines a shape and size of model-specific versions of the digital items. For example, the digital item data store 100 may send data defining vertices of the digital items when fit to different character models but not additional information, such as textures, colors, or physical properties. Additionally or alternatively, the data sent to the containerized environment 110 may comprise a subset of the base transforms for each of the plurality of different character models and categories of digital items fit for those character models.

At step 204, vertices of digital items are matched across character models in containerized environment 110. For example, the containerized environment may identify, for each vertex of a digital item fit to a first character model, a corresponding vertex of the digital item fit to the second character model. In implementations where vertices have been previously matched between character models and/or where vertices are matched manually using different methods, this step may be skipped. Otherwise, methods for performing the matching between digital items fit to different character models are described further herein.

In an implementation, the containerized environment 110 is configured to match vertices from digital items fit to a particular source character model to digital items fit to each of the other (target) character models. For example, if the source character model is a male human model, the containerized environment 110 may be configured to match vertices from the digital item fit to the male human model to versions of the digital item fit to each of the other character models. In other implementations, the containerized environment 110 matches vertices for each model-specific digital item across multiple different model-specific character models. Thus, instead of matchings from a same source character model, the containerized environment 110 may match model-specific digital items amongst each combination of character models.

At step 206, a machine learning system is trained in containerized environment 110 using the matched vertices and one or more base transforms. For example, the containerized environment 110 may generate training datasets for one or more different machine learning systems from the matched vertex data. The training data may include, for each digital item, an input matrix and an output matrix. The input matrix may comprise coordinates for each vertex of a human-male-specific version of a digital item and the output matrix may comprise coordinates for each corresponding vertex of the female-dwarf-specific version of the same digital item. The locations of vertices in the input matrix may correspond to the locations of matched vertices in the output matrix. Thus, the first set of coordinates in the input matrix may be coordinates that were matched to the first set of coordinates in the output matrix in step 204.

In an implementation, the machine learning system comprises a linear regression or neural network model configured to compute an output matrix of vertices from an input matrix of vertices based on a base transform matrix. Containerized environment 110 may be configured to initialize a single machine learning system that matches between two different character models and/or a plurality of machine learning systems where each machine learning system matches between two different character models. Thus, a first machine learning system may be configured to compute a size and shape of model-specific versions of digital items fit to a female pandaren from data defining a size and shape of model-specific versions of digital items fit to a male human and from base transforms of digital items from a male human to a female pandaren. A second machine learning system is configured to compute a size and shape of model-specific versions of digital items fit to a male goblin from data defining a size and shape of model-specific versions of digital items fit to the male human and from base transforms of digital items from a male human to a male goblin.

Implementations may include machine learning systems trained with reversed inputs and outputs, such that one may compute a size and shape of digital items fit to a female pandaren from data defining a size and shape of digital items fit to a male human while a second computes a size and shape of digital items fit to a male human from data defining a size and shape of digital items fit to a female pandaren. Implementations may also include machine learning systems with different combinations of models, such as female pandaren to male goblin. In an implementation, a machine learning system may be initialized and trained for different categories of digital items. For example, one or more machine learning systems may be initialized and trained for computing model-specific sizes and shapes of helmets from data defining a model-specific size and shape of an input helmet, in addition to being trained to generate model-specific sizes and shapes of shoulder armor from data defining a model-specific size and shape of an input shoulder armor.

In an implementation, different machine learning systems may be initialized and trained for different pairs of character models. For example, one or more first machine learning systems may be initialized and trained for computing sizes and shapes of armor pieces for a male tauren character model from data defining the sizes and shapes of input armor pieces for a human male character model and from base transforms for those two character models. One or more second machine learning systems may be trained to compute sizes and shapes of armor pieces for a female mechagnome character model from data defining the sizes and shapes of input armor pieces for a human male character model and from base transforms for those two character models.

Machine learning systems for computing a shape and size of three-dimensional digital objects to fit a second character model based on the shape and size that the same three-dimensional digital objects fit to a first character model and on a base transform for the first character model and second character model are described further herein. Containerized environment 110 may utilize the methods described herein to initialize the one or more machine learning systems and individually train the machine learning systems using the data retrieved from digital item data store 100. In other implementations, a plurality of containerized environments is used with each trained machine learning systems for different combinations of character models. Thus, a plurality of machine learning models may be trained in parallel based on different training datasets. The use of a plurality of containerized environments additionally allows a smaller subset of data to be sent to different containerized environments and for the different environments to perform the matching in parallel. For instance, if each digital item is fit to twenty different character models, an individual containerized environment may only require data defining the digital items when fit to two character models, the input character model and the output character model, plus the base transform corresponding to the input character model and the output character model.

At step 208, a trained machine learning system is sent from containerized environment 110 to server computer 120. For example, the containerized environment 110 may be configured to send trained machine learning systems to the server computer 120. The server computer 120 may use the trained machine learning systems to compute outputs. By offloading the generation and training of the machine learning systems, the server computer 120 is able to provide the functionality of the machine learning systems without the resource expenditure or high storage costs of obtaining all of the input data and training each machine learning system used.

At step 210, server computer 120 stores the trained machine learning system. For example, the server computer 120 may store the trained machine learning system or systems in memory until a request is received to produce a new output using the stored machine learning system or systems.

At step 212, a client computing device 130 sends new digital item data for a first character model. For example, the server computer 120 may provide a graphical user interface through which a client computing device 130 may upload data defining a new digital item that is fit to a first character model. The data defining the new digital item may comprise data defining the location of the vertices of the new digital item and data defining which vertices are connected. The data may additionally include data that identifies the character model to which the new digital item is fit. For example, if the new digital item was originally designed as being fit to a female orc, the client computing device 130 may send, along with the data defining vertices of the new digital item, an indication that the item was fit to a female orc, thereby allowing the server computer 120 to select the correct machine learning systems for computing outputs.

At step 214, the server computer 120 computes one or more output digital items for a second character model. For example, the server computer 120 may generate one or more input data sets. One or more of the input data sets may comprise coordinates of each vertex of the new digital item fit to the first character model. The server computer 120 may then feed the one or more input data sets into the machine learning system to compute one or more output data sets coordinates of each vertex of the new digital item fit to the second character model. One or more of the output data sets may comprise coordinates generated using an input data set comprising coordinates of each vertex of the new digital item fit to the first character model. Additionally or alternatively, one or more of the output data sets may be generated using a machine learning system trained using a base transform corresponding to the first character model and the second character model. Additionally or alternatively, one or more of the output data sets may be generated using a machine learning system trained using an input data set comprising both the coordinates of each vertex of the new digital item fit to the first character model, as well as the base transform corresponding to the first character model and the second character model.

The server computer 120 may then use data defining which vertices are connected for the new digital item to connect the vertices of each of the one or more output data sets, thereby generating one or more versions of an output model-specific digital item. For example, if the first and fourth vertex of the new digital item fit to the first character model were connected, then the server computer may determine that the first and fourth vertex of the new digital item fit to the second character model should be connected. In this manner, full models are rebuilt from vertex coordinates.

At step 216, the server computer 120 performs one or more post-processing techniques on the one or more output data sets. By performing one or more of these post-processing techniques, the server computer 120 can generate one or more additional output model-specific digital items.

For example, the server computer 120 may enforce local symmetry within output model-specific digital items represented by the one or more output datasets. As used herein, the term “local symmetry” and related terms may refer to symmetry with respect to a given plane of symmetry of a submesh of a digital item. For example, a cuirass fit for a human character model may have a lefthand chest portion and a righthand chest portion that are symmetrical with each other. If the lefthand chest portion and righthand chest portions become asymmetrical when the cuirass is fit for an orc character model, the server computer 120 may modify the digital item to enforce symmetry between the two portions. The process of enforcing local symmetry within an output model-specific digital item is described in greater detail below.

As another example, the server computer 120 may repair any instances of the output model-specific digital items clipping into a portion of second character model when affixed to the second character model. As used herein, “clipping” and related terms may refer to a graphical artifact that occurs when one or more vertices of a digital item unintentionally insects and penetrates into a portion of a character model in a manner that may result in an undesirable visible effect. The process of repairing clipped vertices of an output model-specific digital item is described in greater detail below.

At step 218, the server computer 120 sends the one or more output digital items--including output digital items generated at both step 214 and step 216-to the client computing device 130. For example, the server computer may cause display of the one or more output digital items on the client computing device 130 through a graphical user interface. The display may additionally include the second character model to which the digital item is fit. Thus, if a helmet fit to a male human was fit to a female goblin, the server computer may display the helmet being worn by the female goblin character model. In an implementation, the server computer computes one or more outputs for each of a plurality of different character models and causes display of each output on the client computing device 130. For example, if the server computer stores machine learning systems for each of a plurality of output character models, the server computer may compute one or more outputs with each of the plurality of machine learning systems and cause display of each output with their corresponding character model.

### Vertex Matching

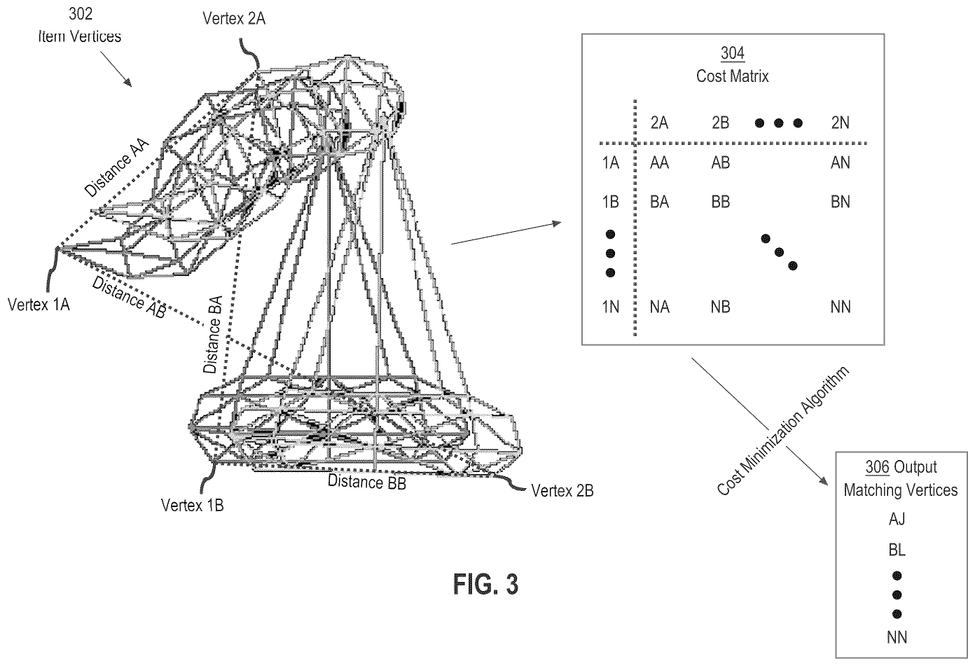

FIG. 3 depicts an example method for performing vertex matching for digital items scaled to different character models. The example of FIG. 3 may be performed for a plurality of combinations of character models for a same digital item. For example, a first matching of vertices may be performed between a male human model and a female goblin model while a second matching of vertices may be performed between the male human model and a male pandaren model. Multiple sets of matched vertices may be used to produce new matchings between models without performing the method of FIG. 3. For example, the system may directly generate a matching of vertices between the male pandaren model and the female goblin model.

Item vertices 302 comprise a visual representation of vertices of two versions of a same digital item fit to different character models. The vertices may be extracted from data defining the digital item, such as from a mesh that serves as the backbone for the digital item. While item vertices 302 are depicted as three-dimensional visual representations, in implementations item vertices 302 may be defined by a set of coordinates in three-dimensional space and by the vertices to which they connect. For example, vertex 1A may be defined as a set of (u, v) texture coordinates and data identifying the three vertices to which vertex 1A connects. While examples are discussed with respect to texture coordinates, any set of coordinates in three-dimensional space may be used, such as spherical coordinates or Euclidean coordinates.

Vertex 1A and vertex 1B comprise two vertices of model 1, where model 1 comprises a model of the digital item fit to a first character model. Vertex 2A and vertex 2B comprise two vertices of model 2, where model 2 comprises a model of the digital item fit to a second character model. In an implementation, vertices are randomly or pseudo-randomly sampled in each model. Thus, vertex 1A and vertex 2A comprise vertices in different locations of the models. In an implementation, the system samples vertices until each vertex of the digital item has been identified in each model.

Using the distances between vertices of the digital items, the system generates cost matrix 304. Cost matrix 304 comprises a matrix of distances between vertices of model 1, as represented by the rows of cost matrix 304, and vertices of model 2, as represented by the columns of cost matrix 304.

After generating the cost matrix 304, the system may use a cost minimization algorithm to identify vertex matches which, in aggregate, minimize a total cost (or distance) between matched vertices. For example, the system may use a Kuhn-Munkres algorithm or any other combinatorial optimization algorithm to permutate rows and columns of the cost matrix to minimize the trace of the matrix.

Output matching vertices 306 comprise the outputs of using the cost minimization algorithm on the cost matrix 304. The outputs comprise identifiers of vertices that were matched between the models. For example, vertex A of model 1 was matched to vertex J of model 2, vertex B of model 1 was matched to vertex L of model 2, and, coincidentally, vertex N of model 1 was matched to vertex N of model 2.

Matched vertices may be used to generate training datasets as inputs and corresponding outputs. For example, output matching vertices 306 of FIG. 3 may be separated into two columns, a column corresponding to the vertices of model 1 and a column corresponding to the matched vertices of model 2, wherein a vertex in a particular row of one column was matched to a vertex in the particular row of the other column. Thus, the input column generated from output matching vertices 306 may comprise a column of (A, B, . . . , N) while the output column comprises a column of (J, L, . . . , N), where each vertex letter is replaced by the vertex's coordinates.

In some situations, a version of a digital item fit to a first character model may have a different number of vertices than a version of the digital item fit to a second character model. In an implementation, the cost matrix is supplemented with additional rows or columns comprising high distance values to generate a square cost matrix. Thus, when the cost minimization algorithm is performed, the vertices that are matched to the high distance values are discarded and not used to generate the training datasets.

### Repairing Clipped Vertices

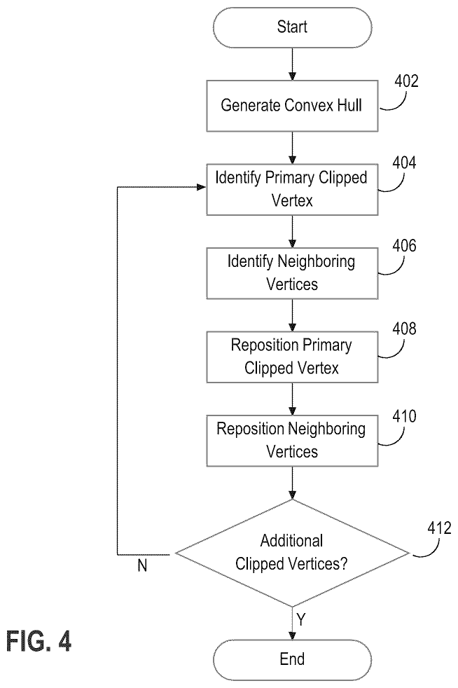

FIG. 4 depicts an example method of repairing clipped vertices in of an output model-specific digital item. When a digital item fit to a first character model is transformed to fit a second character model (or is fit to a first character model initially), one or more vertices of the output model-specific digital item may clip into a portion of the second character model when affixed to the second character model. These instances of clipping may produce an undesirable visual effect and may otherwise necessitate manual repair of the output model-specific digital item. A post-processing technique may be applied to output model-specific digital items to repair these clipped vertices. While FIG. 4 describes an example in which clipped vertices of an output model-specific digital item are repaired, the method of FIG. 4 may likewise be applied to any digital item fit to a character model.

At step 402, a convex hull may be generated that corresponds to a portion of the second character model to which the output model-specific digital item is affixed. As used herein, a “convex hull” a smallest possible convex shape capable of enclosing every vertex of the output model-specific digital item. For example, if the output model-specific digital item is a vambrace fit for a goblin character model, a convex hull corresponding to an arm portion of the goblin digital model may be generated. The output model-specific digital item may be affixed to the convex hull in a same manner as it would be affixed to the corresponding portion of the second character model.

At step 404, a primary clipped vertex is identified. The primary clipped vertex represents a vertex that is clipped into a surface of the convex hull to a greatest degree when the output model-specific digital item is affixed to the convex hull. The primary clipped vertex may be identified from a list of clipped vertices that are detected within the output model-specific digital item. The degree of clipping for each vertex can be determined based on, for example, the distance between each clipped vertex and a nearest point on a surface of the second character model.

At step 406, one or more neighboring vertices to the primary clipped vertex are identified. The neighboring vertices may include those vertices that are adjacent to and/or within a predetermined distance of the primary clipped vertex.

At step 408, primary clipped vertex is repositioned. Repositioning the primary clipped vertex may include applying a three-dimensional translation of the primary clipped vertex to a point on the convex hull that is closest to the primary clipped vertex. This translation of the primary clipped vertex may result in the primary clipped vertex no longer being clipped.

At step 410, the one or more neighboring vertices are repositioned. The one or more neighboring vertices can be repositioned based on the translation vector that moved the primary clipped vertex in step 408. For example, a translation vector applied to each of the one or more neighboring vertices may include a same directional component as the primary clipped vertex's translation vector. As another example, the translation vector applied to each of the one or more neighboring vertices may include a distance (or magnitude) component that is a ratio of the distance component of the primary clipped vertex. This ratio may be based on a distance between each neighboring vertex and the primary clipped vertex: the translation distance for a neighboring vertex may have a reverse proportionality to the neighboring vertex's distance from the primary clipped vertex. Thus, neighboring vertices that are closer to the primary clipped vertex may have a greater translation distance than neighboring vertices that are further away from the primary clipped vertex. This translation of the one or more neighboring vertices may or may not result in one or more of the neighboring vertices no longer being clipped.

At step 412, any remaining clipped vertices from the output model-specific digital item may be identified. If there are no remaining clipped vertices, execution may proceed back step 402. That is, a new primary clipped vertex may be identified, and the new primary clipped vertex and its neighboring vertices may be repositioned as discussed in steps 402-410. If no clipped vertices remain in the output model-specific digital item, execution may proceed to completion, and a processed version of the model-specific digital item may be output. In other implementations, whether execution proceeds back to step 402 may be based on an alternative termination condition. As an example, an alternative termination condition can include determining whether a clipping distance of each remaining clipped vertex falls below a minimum threshold. As another example, an alternative termination condition can include a predefined stopping point such as a number of times primary clipped vertices have been repositioned.

### Enforcing Local Symmetry

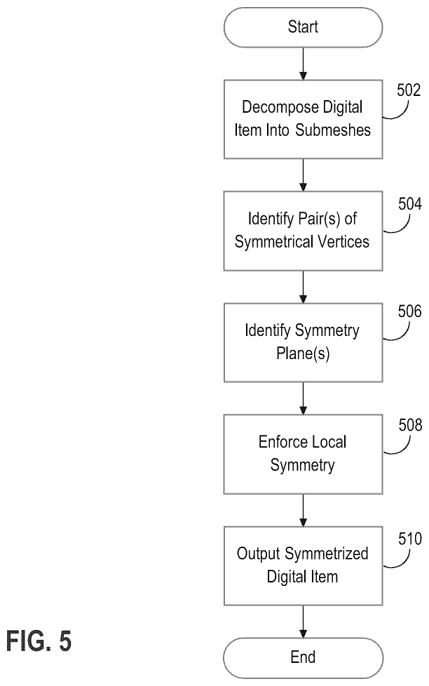

FIG. 5 depicts an example method of enforcing local symmetry within an output model-specific digital item. When a digital item fit for a first character model is adjusted to fit a second character model, one or more portions of the digital item may lose symmetries that were existed in the digital item fit to the first character model. While FIG. 5 describes an example in which local symmetry is enforced within an output model-specific digital item, the method of FIG. 5 may likewise be applied to any digital item fit to a character model.

In some implementations, the symmetry of a digital item can be enforced with respect to the YZ plane. In other examples, however, the symmetry plane for a digital item may need to be determined before local symmetry can be enforced. In those situations, a UV map for the digital item may be used to find the digital item's symmetry plane. A UV map as used herein may represent a two-dimensional representation of how the surface of a three-dimensional digital item is textured. When designing a texture for a symmetrical digital item, a texture that is applied to one portion of the digital item's UV map may be “mirrored” and applied to an opposing portion of the digital item's UV map. Consequently, those portions of the digital item will be symmetrical when the texture is mapped onto the digital item's three-dimensional model. This characteristic of the digital item's UV map can be used to identify a symmetry plane in a version of the digital item that is fit to a different character model.

At step 502, a mesh for the digital item can be decomposed into a first sub-mesh and a second sub-mesh. The two sub-meshes may correspond to portions of a digital item that are symmetric when fit to a first character model but become asymmetric when fit to a second character model. The portions of the digital item that correspond to the two sub-meshes may be identified based on, for example, identifying geometric features or patterns that are mirrored with respect to each other within the digital item fit to the first character model. As another example, a same texture that is mapped to two different portions of the digital model fit to the first character model may identified. Once these symmetrical portions of the digital item fit to the first character model are identified, analogous portions of the digital item to the second character model are likewise identified.

At step 504, one or more pairs of symmetrical vertices from the first and second sub-meshes can be identified. When the digital item is fit to the first character model, two portions of the digital model may be symmetrical when the vertices of one portion may be transformed to the vertices of the other portion by a reflection across a plane of symmetry. These pairs of vertices may be identified based on their locations relative to other vertices of the respective portions of the digital item or using any suitable method. The identified pairs of vertices in the digital item fit to the second character model are therefore those that are analogous to the pairs of symmetrical vertices in the digital item fit to the first character model.

At step 506, one or more symmetry planes can be identified for each of the two sub-meshes. For some digital items, the plane of symmetry may be the XY plane, XZ plane, or YZ plane. For other digital items, though, there may not be an obvious plane of symmetry. Thus, for those other digital items, a symmetry plane can be identified based on the one or more pairs of symmetrical vertices identified at step 504. As an example, to identify the plane of symmetry for the one or more pair of symmetrical vertices, axes of symmetry between each pair of vertices may be identified. An axis of symmetry can include a line that connects the pair of symmetrical vertices. A midpoint between these symmetrical vertices may also be identified, which represents a point along the axis of symmetry that is equidistant from both of the pair of vertices. Based on this axis of symmetry, a normal vector of the plane of symmetry may be identified, which may align with the axis of symmetry. The plane of symmetry may be identified using this normal vector and the midpoint between the pair of vertices. In an implementation, any duplicate symmetry planes may be identified based on the normal vector. Each plane of symmetry for the two sub-meshes may likewise be identified. Any suitable for identifying planes of symmetry between two sets of vertices may be used, however.

At step 508, local symmetry between the two sub-meshes can be enforced given the one or more planes of symmetry identified at step 506. For example, each pair of symmetrical vertices of the two sub-meshes may be repositioned such that the vertices of each pair are equidistant from the corresponding plane of symmetry in a same direction. Any suitable for enforcing the symmetry between two sets of vertices may be used, however.

At step 510, the now-symmetrized sub-meshes can be recombined into a symmetrized digital item. The symmetrized digital item may be output as one of the one or more output model-specific digital items.

### Machine Learning System Training

In an implementation, the system uses the coordinates matched using the method of FIG. 3 to train a machine learning system. Additionally or alternatively, the system may receive data identifying matching coordinates, such as coordinates that were identified as matching when the digital items were originally created or coordinates that were manually matched by one or more designers.

In an implementation, the system initializes a regression model and trains the regression model using training input data for a plurality of items. The training input data may comprise for each item, input vertex coordinates of the item when fit to the first character model and matching output vertex coordinates of the item when fit to the second character model. Thus, for a particular model, each set of inputs may correspond to a same character model, such as the male human character model, while each set of outputs corresponds to a particular other character model, such as the female goblin character model. A regression model may be defined as:

$$\hat{y} = f ( x ; w )$$

where ŷ is the predicted output vertices and f(x; w) is a differentiable function of the input vertices, x, and a set of weights, w, which are trained using the training datasets.

In an implementation, the function used for the regression model comprises a function that models different types of transformations and an affinity between a particular vertex and the transformation. The transformations may include any of shear, rotation, scale, translation, or any other three-dimensional transformations. The affinity comprises a weight of the transformation that is dependent on the input coordinates. For example, vertices for helmets will comprise vertices that correspond to parts of the helmet that are closer to the character model's head and parts of the helmet that are further from the character model's head. The vertices closer to the character model's head may be more sensitive to some types of transformations, such as translation, but less sensitive to other types of transformations, such as scale. Thus, the affinity value takes into account an affinity of a vertex to a type of transformation by basing the affinity value, at least in part on the location of the vertex. In an implementation, the affinity value of a particular transformation may be greater if that transformation is part of a base transform matrix.

As a practical example, the regression model may be initialized according to:

$${y}_{i} = {\sum }_{k} {T}_{k} * {A}_{k , {x}_{i}} * {x}_{i}$$

where ŷᵢ is a particular output vertex value, Tₖ is one of k transformation matrices, A_{k,x}_{ᵢ} is the affinity value which is dependent on the transformation type k and the coordinates of the input vertex xᵢ. In an implementation, the transformation matrices comprise (3×4) matrices defining one or more of translation, shear, rotation, or scaling, using known mathematical methods for defining coordinate transformations. The transformation matrices may in some examples comprise a single base transform matrix.

The affinity weight value may be generated using an embedding computed for each of the vertices. For example, PointNet is an existing deep learning network which maps a set of three-dimensional coordinates into 1024 dimension space where points nearby in the embedding have similar semantic properties. The system may generate an initial embedding for the vertices and a separate embedding for each transformation, thereby creating K+1 embeddings where K is the number of transformation matrices. The affinity weight value may then be computed as:

$${A}_{k , {x}_{i}} ( x ; w ) = softmax ( {[ {e}_{a} ( {x}_{i} , x ; w ) * {e}_{l} ( {x}_{i} , x ; w ) ∀ l ]}_{k} )$$

where eₐ is the initial embedding and eₗ is the embedding for the transformation.

In an implementation, the transformation matrices and affinity matrices are parameterized with weights using a machine learning system, such as a deep neural network which uses each full set of coordinates as inputs. Thus, the above regression model may be rewritten as:

$${\hat{y}}_{i} = {\sum }_{k} {T}_{k} ( x ; w ) * {A}_{k , {x}_{i}} ( x ; w ) * {x}_{i}$$

to indicate that Tₖ and A_{k,x}_{ᵢ} are both parameterized according to sets of input vertices x and weights w. An example deep learning network which can be used to parameterize the transformation matrices and affinity values is the PointNet which is commercially available on online repositories, such as GitHub. A different PointNet may be used for each transformation and for the computing affinities.

While many machine learning systems perform predictions for which there are definite outcomes, the models described herein are configured to provide outcomes which comprise a level of subjectivity. The training datasets may include digital items that were fit differently to a single character model based on differences in taste, effort, or skill. For example, a first designer may scale horns of a helmet based on a height of the character model's head while a second designer may scale horns of the helmet based on a length of the character model's head.

In an implementation, the system defines a plurality of different regression models which are used in both the training step and the model usage step. The plurality of different regression models may be used to capture different types of fitting of digital items from one character model to a second character model. The plurality of different regression models may likewise be based on base transforms that capture these different types of fittings. Given j regression models, the above equation may be rewritten as:

$${\hat{y}}_{i , j} = {\sum }_{k} {T}_{k , j} ( x ; w ) * {A}_{k , j , {x}_{i}} ( x ; w ) * {x}_{i}$$

thereby predicting j outcomes based on models parameterized to different weights. During the training phase, results from the plurality of models may be used as part of the training information. Thus, instead of using the standard regression loss in gradient descent, the system may compute the regression loss as:

$${min}_{j} \vert {\hat{y}}_{i , j} - {y}_{i} \vert$$

such that only the closest prediction is used to fit the models. Each model may be initialized with different starting weights, thereby allowing the training step to converge the models differently. During the updating step of the training phase, the model that generated the closest prediction may be updated.

In an implementation, a model may be trained using one of a plurality of different base transforms of digital items from a first character model to a second character model. Each of these base transforms may reflect different artistic choices for how the digital items should be fit to the second character model. To determine which of these base transforms may be used to train a model, training input data may be separated into multiple clusters, where each cluster corresponds to a different base transform. Each base transform may be applied to digital items fit for the first character model, and the results may be compared to a ground truth to determine which result is most similar to the ground truth. The model may be trained using the cluster corresponding to the base transform that produced a result most similar to the ground truth.

Implementations of the model described above generate a one-to-one prediction of vertices for an output three-dimensional digital item fit to a second character model from vertices of an input three-dimensional digital item fit to a first character model. Thus, if multiple transformations are desired, such as in a case where a single item may need to be fit to a plurality of different character models, the system may initialize a plurality of machine learning systems and train the plurality of machine learning systems with different inputs or outputs. Thus, a first machine learning system may be initialized and trained using digital items fit to a male human and base transforms of digital items from a male human to a female goblin as inputs, and digital items fit to female goblins as outputs. A second machine learning system may be initialized and trained using digital items fit to a male human and base transforms for digital items from a male human to a male pandaren as inputs and digital items fit to a male pandaren as outputs. Different machine learning systems may additionally be initialized and trained for different types of items. For example, a first model may correspond to helmets while a second model corresponds to chest armor. The models may be initialized and trained in a single containerized environment and/or may be initialized and trained in parallel in a plurality of containerized environments.

### Model Usage

The machine learning systems described above may be used to generate different versions of a three-dimensional digital item fit to different character models. For instance, a designer may generate a new three-dimensional digital item fit to a specific character model, such as a helmet fit to a male human character model. The designer may use a client computing device to send a request to a server computer to generate one or more different versions of the new three-dimensional digital item fit to different character models. In an implementation, the client computing device specifies a character model to which the new three-dimensional digital item was initially fit and/or identifies one or more character models to which the new three-dimensional digital item is to be fit. The client computing device may also specify a base transform to use in fitting the new three-dimensional digital item. The client computing device may send the new three-dimensional digital item to the server computer and/or data defining the vertices of the new three-dimensional digital item.

When the server computer receives the request, the server computer may identify one or more machine learning systems to use to satisfy the request. For example, the server computer may identify machine learning systems trained with inputs corresponding to a same character model as the new three-dimensional digital item and outputs corresponding to a requested output character model. As another example, the server computer may identify machine learning systems trained using base transforms for the same character model as the new three-dimensional digital item and the requested output character model. Thus, if the request identifies the input as a male human and the outputs as female goblin and male pandaren, the server computer may identify a male human to female goblin model and a male human to male pandaren model. In an implementation, the outputs are computed in parallel by multiple processes or multiple server computers. In an implementation, the server computer automatically identifies each machine learning system which uses as the input digital items fit to the character model to which the new three-dimensional digital item is fit.

After the model has been identified, the server computer may use the vertex data for the new three-dimensional digital object to compute vertices for output three-dimensional digital objects fit to the one or more character models. In an implementation, the server computer additionally recreates a digital mesh using the vertices. For example, the server computer may receive data identifying connections between vertices. When the new locations for the vertices are computed for a particular output digital object, the server computer may rebuild the connections between the vertices based on the received data. Thus, if vertex A was connected to vertex J, the server computer may connect vertex A′ to vertex J′.

In implementations that use the plurality of regression models for a single machine learning system, the server computer may compute a plurality of results and provide the plurality of results to the client computing device. For example, using the machine learning model defined by:

$${\hat{y}}_{i , j} = {\sum }_{k} {T}_{k , j} ( x ; w ) * {A}_{k , j , {x}_{i}} ( x ; w ) * {x}_{i}$$

a machine learning system computes j output sets of vertices. The server computer may generate a version of the new digital item according to each of the output sets of vertices. Thus, if j=4, the server computer may generate four different versions of the new three-dimensional digital object fit to a particular character.

In an implementation, the server computer provides, to the client computing device, a graphical user interface in which the plurality of output digital items is depicted with a corresponding character model. For example, if the machine learning system computed four output sets of vertices for a digital item fit to a female goblin character model, the server computer may display four versions of the female goblin character model wearing versions of the digital item corresponding to the four output sets of vertices.

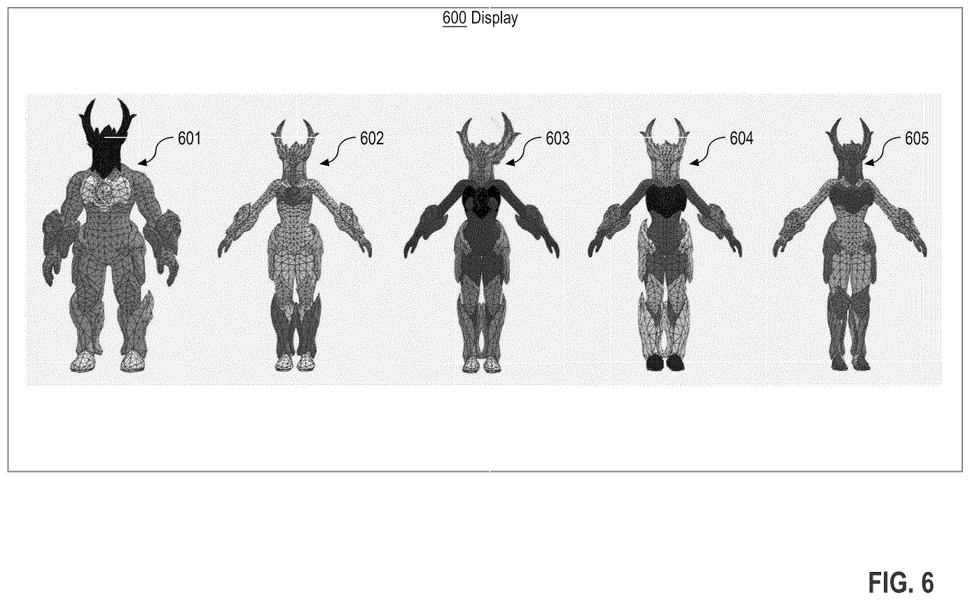

FIG. 6 depicts an example interface presenting a character model combined with an output three-dimensional digital item.

Visualization 600 comprises examples of an input 601 a ground truth 602, and three outputs, output 603, output 604, and output 605, generated using the systems and methods described herein. The five outputs comprise a same set of digital items fit to two different character models. Input 601 comprises the set of digital items it to a human male character model. Ground truth 602 comprises an artist fit of the set of digital items to a female elf character model. Output 603 comprises an output generated by the machine learning system as described in FIG. 2. Output 604 comprises output 603 with the post-processing techniques described in FIGS. 4 and 5 applied. Output 605 comprises an output generated only using a base transform that was generated using the artist fit ground truth 602. In some implementations, an additional output may be generated for each of the techniques used to generate outputs 603-605 using different approaches.

Given variances in the techniques used to generate each one, the outputs have slight variations. For instance, output 603 shows clipping of the cuirass into the character model's chest, and an asymmetry in the horns of the helm. By displaying a plurality of outcomes generated using the plurality of different machine learning systems, the server computer is able to account for stylistic differences and poor-quality translations in the training data, thereby allowing a user to make a final decision as to a best version of the digital item fit to the character model.

In an implementation, the server computer executes one or more post-processing rules to repair outputs that meet particular criteria. For example, the server computer may determine whether portions of the character model overlap with portions of the digital item, thereby causing the clipping depicted in output 603. If the server computer identifies clipping in an output, the server computer performs the method described in FIG. 4 to repair this clipping and generate a new output 604 with the clipping repaired. Likewise, if the server computer determines that output 603 fails to preserve a local symmetry within the helm of input 601, the server computer may generate a new output 604 in which that local symmetry is enforced.

Implementations described above may be implemented when a new digital item is created and fit to an existing character model. Similarly, implementations may be implemented when a new character model is created and fit to a plurality of digital items. For example, when a designer generates a new character model, a large number of existing stored digital items may need to be fit to the new character model,

In an implementation, the methods described herein may be used to initialize and train a new machine learning system for a new character model. A client computing device may initially send a request to the server computer for a new machine learning system. The request may include a new character model, a plurality of three-dimensional digital items from the digital item datastore that are fit to the new character model, and potentially one or more base transforms of various categories of digital items to the new character model. Additionally or alternatively, the new character model and/or the plurality of three-dimensional digital items fit to the new character model may be stored in the digital item datastore and the client computing device may identify the stored data to the server computer.

For each three-dimensional digital item fit to the new character model, the system may identify a corresponding version of the three-dimensional digital item fit to an existing character model. Data identifying vertices for the three-dimensional digital items fit to the new character model and to the existing character model may be sent to the containerized environment. A base transform from the existing character model to the new character model for a category of those digital items may also be identified and provided to the containerized computing environment.

The containerized environment may train the machine learning system using the received data and send the resulting machine learning system to the server computer. The server computer may then request, from the digital item datastore, data for digital items that were not initially fit to the new character model, as well as base transforms associated with those digital items and character models. The server computer may use the machine learning system to compute outputs for the received data, thereby fitting a plurality of existing items to the new character model.

As a practical example, one or more designers may generate a humanoid rat creature as a new character model for a game. The one or more designers may further manually fit a plurality of existing helmets to the humanoid rat creature through manual manipulation of the stored helmets. In an implementation, the server computer may require a minimum number of items to be fit to the new character model, such as 100 items, prior to generating and training the machine learning system. In another implementation, the server computer may initiate generating and training the machine learning system when one or more base transforms for the humanoid rat creature character model are created.

The designer may then send a request, through the client computing device, for the server computer to fit the remaining helmets to the humanoid rat creature, using data defining vertices of the existing helmets that have been modified to fit the humanoid rat creature. The server computer may then request that the containerized environment initialize and train a machine learning model using data defining vertices of the existing helmets fit to a male human character model as inputs and the data defining vertices of the existing helmets fit to the humanoid rat creature as outputs. After the machine learning system has been initialized and trained, the server computer may request and receive data defining a remainder of the existing helmets fit to the male human character from the digital item datastore and use the data as inputs into the machine learning system to compute output helmets fit to the humanoid rat creature.

The systems and methods described herein may additionally be used to improve existing items fit to character models. For example, the server computer may identify a plurality of digital items fit to a particular character model for improvement. The server computer may identify the digital items based on user input identifying the digital items, based on determining that the digital items meet one or more criteria, such as clipping into a character model or violating a local symmetry, based on the creation of a new base transform for the item, and/or based on metadata associated with the item, such as a date of creation. The server computer may use a version of the item fit to a different character model as input and compute a new output for the item. The server computer may then replace the existing item with the newly generated item. For example, if a helmet was poorly fit to a female orc, the server computer may use a version of the helmet fit to a male human as input and compute an output helmet fit to the female orc using a machine learning system. The machine learning system may be trained with helmets fit to the male human and/or a base transform of a helmet from a male human to a female orc as inputs and helmets fit to the female orc as outputs. The server computer may send the output to a client computing device for confirmation and/or may send the output to the digital item datastore to replace the existing version fit to the female orc.

### Machine Learning Model

A machine learning model is trained using a particular machine learning algorithm. Once trained, input is applied to the machine learning model to make a prediction, which may also be referred to herein as a predicated output or output.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output, as described above. In an implementation, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or predication, a computer system process executing a machine learning algorithm applies the model artifact against the input to generate a predicted output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e., configurable) implementations of best of breed machine learning algorithms may be found in open source libraries such as Google's TensorFlow for Python and C++ or Georgia Institute of Technology's MLPack for C++. Shogun is an open-source C++ ML library with adapters for several programing languages including C #, Ruby, Lua, Java, Matlab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input node, the activation value is simply an input value for the input. For an activation neuron, the activation value is the output of the respective activation function of the activation neuron.

Each edge from a particular node to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation node, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of nodes in layer L−1 and L is N[L−1] and N[L], respectively, the dimensions of matrix W are N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input node. The particular input may be stored as vector. Training data comprises multiple inputs, each being referred to as sample in a set of samples. Each sample includes a value for each input node. A sample may be stored as a vector of input values, while multiple samples may be stored as a matrix, each row in the matrix being a sample.

When an input is applied to a neural network, activation values are generated for the hidden layers and output layer. For each layer, the activation values may be stored in one column of a matrix A having a row for every node in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of nodes and/or edges determines the size of matrices needed to implement a neural network. The smaller the number of nodes and edges in a neural network, the smaller matrices and amount of memory needed to store matrices. In addition, a smaller number of nodes and edges reduces the amount of computation needed to apply or train a neural network. Less nodes means less activation values need be computed, and/or less derivative values need be computed during training.

Properties of matrices used to implement a neural network correspond neurons and edges. A cell in a matrix W represents a particular edge from a node in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e., number of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have different values. The arithmetic or geometric difference between correct and actual outputs may be measured as error according to a loss function, such that zero represents error free (i.e., completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e., ceases to reduce) or vanishes beneath a threshold (i.e., approaches zero). Example mathematical formulae and techniques for feedforward multilayer perceptron (MLP), including matrix operations and backpropagation, are taught in a related reference “Exact Calculation Of The Hessian Matrix For The Multi-Layer Perceptron,” by Christopher M. Bishop, the entire contents of which are hereby incorporated by reference as if fully set forth herein.

Model training may be supervised or unsupervised. For supervised training, the desired (i.e., correct) output is already known for each example in a training set. The training set is configured in advance by (e.g., a human expert, or via the labeling algorithm described above) assigning a categorization label to each example. For example, the training set for ML model 1316 is labeled, by an administrator, with the workload types and/or operating systems running on the server device at the time the historical utilization data was gathered. Error calculation and backpropagation occurs as explained above.

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g., anecdotal) or otherwise incomplete understanding of a problem space by a human expert. Whereas unsupervised training discovers an apt intermediate vocabulary based more or less entirely on statistical tendencies that reliably converge upon optimality with sufficient training due to the internal feedback by regenerated decodings. A supervised or unsupervised ANN model may be elevated as a first-class object that is amenable to management techniques such as monitoring and governance during model development such as during training.

### Deep Context Overview

As described above, an ANN may be stateless such that timing of activation is more or less irrelevant to ANN behavior. For example, recognizing a particular letter may occur in isolation and without context. More complicated classifications may be more or less dependent upon additional contextual information. For example, the information content (i.e., complexity) of a momentary input may be less than the information content of the surrounding context. Thus, semantics may occur based on context, such as a temporal sequence across inputs or an extended pattern (e.g., compound geometry) within an input example. Various techniques have emerged that make deep learning be contextual. One general strategy is contextual encoding, which packs a stimulus input and its context (i.e., surrounding/related details) into a same (e.g., densely) encoded unit that may be applied to an ANN for analysis. One form of contextual encoding is graph embedding, which constructs and prunes (i.e., limits the extent of) a logical graph of (e.g., temporally or semantically) related events or records. The graph embedding may be used as a contextual encoding and input stimulus to an ANN.

Hidden state (i.e., memory) is a powerful ANN enhancement for (especially temporal) sequence processing. Sequencing may facilitate prediction and operational anomaly detection, which can be important techniques. A recurrent neural network (RNN) is a stateful MLP that is arranged in topological steps that may operate more or less as stages of a processing pipeline. In a folded/rolled implementation, all of the steps have identical connection weights and may share a single one-dimensional weight vector for all steps. In a recursive implementation, there is only one step that recycles some of its output back into the one step to recursively achieve sequencing. In an unrolled/unfolded implementation, each step may have distinct connection weights. For example, the weights of each step may occur in a respective column of a two-dimensional weight matrix.

A sequence of inputs may be simultaneously or sequentially applied to respective steps of an RNN to cause analysis of the whole sequence. For each input in the sequence, the RNN predicts a next sequential input based on all previous inputs in the sequence. An RNN may predict or otherwise output almost all of the input sequence already received and also a next sequential input not yet received. Prediction of a next input by itself may be valuable. Comparison of a predicted sequence to an actually received (and applied) sequence may facilitate anomaly detection, as described in detail above.

Unlike a neural layer that is composed of individual neurons, each recurrence step of an RNN may be an MLP that is composed of cells, with each cell containing a few specially arranged neurons. An RNN cell operates as a unit of memory. An RNN cell may be implemented by a long short term memory (LSTM) cell. The way LSTM arranges neurons is different from how transistors are arranged in a flip flop, but a same theme of a few control gates that are specially arranged to be stateful is a goal shared by LSTM and digital logic. For example, a neural memory cell may have an input gate, an output gate, and a forget (i.e., reset) gate. Unlike a binary circuit, the input and output gates may conduct an (e.g., unit normalized) numeric value that is retained by the cell, also as a numeric value.

An RNN has two major internal enhancements over other MLPs. The first is localized memory cells such as LSTM, which involves microscopic details. The other is cross activation of recurrence steps, which is macroscopic (i.e., gross topology). Each step receives two inputs and outputs two outputs. One input is external activation from an item in an input sequence. The other input is an output of the adjacent previous step that may embed details from some or all previous steps, which achieves sequential history (i.e., temporal context). The other output is a predicted next item in the sequence.

Sophisticated analysis may be achieved by a so-called stack of MLPs. An example stack may sandwich an RNN between an upstream encoder ANN and a downstream decoder ANN, either or both of which may be an autoencoder. The stack may have fan-in and/or fan-out between MLPs. For example, an RNN may directly activate two downstream ANNs, such as an anomaly detector and an autodecoder. The autodecoder might be present only during model training for purposes such as visibility for monitoring training or in a feedback loop for unsupervised training. RNN model training may use backpropagation through time, which is a technique that may achieve higher accuracy for an RNN model than with ordinary backpropagation.

### Hardware Overview

According to one implementation, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

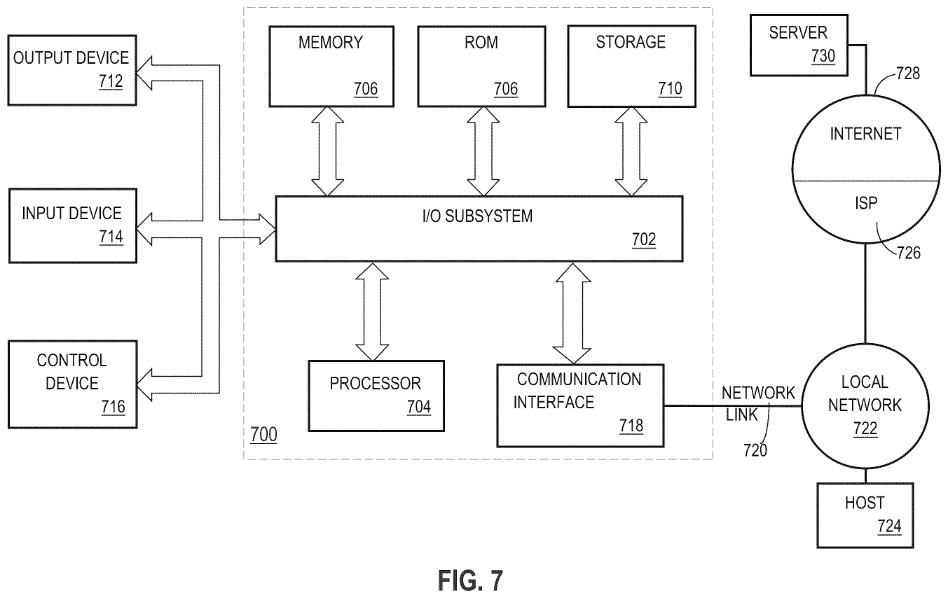

For example, FIG. 7 is a block diagram that illustrates a computer system 700 upon which an implementation may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one implementation, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative implementations, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, implementations have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
storing, at a server computer, a machine learning system configured to compute a shape and a size of three-dimensional digital objects fit for a second character model based on a shape and a size of the three-dimensional digital objects fit for a first character model;
generating, using the machine learning system, a base transform matrix corresponding to a first exemplary three-dimensional digital object fit for the first character model and a second exemplary three-dimensional digital object fit for the second character model;
training the machine learning system using the base transform matrix and machine-learning training data;
receiving, from a client computing device, input data defining a plurality of input vertices for an input three-dimensional digital object fit for the first character model; and
generating, using the machine learning system, output data defining a plurality of output vertices for an output three-dimensional digital object for the second character model.

2. The method of claim 1, wherein:
the base transform matrix comprises a plurality of vertex distances, and
individual vertex distances of the plurality of vertex distances comprise a distance from a vertex of the first exemplary three-dimensional digital object fit for the first character model to a vertex of the second exemplary three-dimensional digital object fit for the second character model.

3. The method of claim 1, wherein the machine-learning training data comprises a plurality of input matrices corresponding to a plurality of three-dimensional digital objects fit for the first character model and a plurality of output matrices corresponding to the plurality of three-dimensional digital objects fit for the second character model.

4. The method of claim 1, wherein the second exemplary three-dimensional digital object digital fit for the second character model comprises a particular characteristic associated with the second character model, and the output three-dimensional digital object comprises the particular characteristic associated with the second character model.

5. The method of claim 1, wherein:
the machine learning system is a first machine learning system,
the base transform matrix is a first base transform matrix,
the output data is first output data,
the plurality of output vertices is a first plurality of output vertices, and
the output three-dimensional digital object is a first output three-dimensional digital object,
the method further comprising:
storing, at the server computer, a second machine learning system configured to compute the shape and the size of the three-dimensional digital objects fit for the second character model based on the shape and the size of the three-dimensional digital objects fit for the first character model;
generating, by the second machine learning system, a second base transform matrix corresponding to the first exemplary three-dimensional digital object fit for the first character model and a third exemplary three-dimensional digital object fit for the second character model;
training the second machine learning system using the second base transform matrix and the machine learning training data; and
generating, by the second machine learning system, second output data defining a second plurality of output vertices for a second output three-dimensional digital object for the second character model.

6. The method of claim 5, further comprising:
causing display, on the client computing device, the first output three-dimensional digital object overlaid with the second character model and the second output three-dimensional digital object overlaid with the second character model; and
receiving, from the client computing device, a selection of one of the first output three-dimensional digital object or the second output three-dimensional digital object.

7. The method of claim 5, wherein the first base transform matrix is excluded from generating the second output data, and the second base transform matrix is excluded from generating the first output data.

8. The method of claim 1, wherein the base transform matrix is a first base transform matrix, the method further comprising:
separating the machine-learning training data into a first cluster corresponding to the first base transform matrix and a second cluster corresponding to a second base transform matrix;
applying a first transformation corresponding to the first base transform matrix to a plurality of vertices associated with the output three-dimensional digital object;
applying a second transformation corresponding to the second base transform matrix to the plurality of vertices associated with the output three-dimensional digital object;
comparing a result of the first transformation and a result of the second transformation with a ground truth; and
selecting the first base transform based at least in part on a similarity of the result of the first transformation with the ground truth, wherein the machine learning system is trained using data from the first cluster corresponding to the first base transform matrix.

9. A system comprising:
one or more processors; and
a memory storing instructions that, when executed by the one or more processors, cause performance of:
generating a convex hull for at least a portion of a character model corresponding to a three-dimensional digital object;
affixing the three-dimensional digital object to the convex hull;
identifying a first clipped vertex from a plurality of vertices of the three-dimensional digital object;
identifying one or more neighboring vertices of the first clipped vertex from the plurality of vertices of the three-dimensional digital object;
repositioning the first clipped vertex to a nearest point on a surface of the convex hull; and
repositioning individual neighboring vertices of the one or more neighboring vertices based at least in part on the repositioning of the first clipped vertex.

10. The system of claim 9, wherein the first clipped vertex is clipped into a surface of the convex hull to a greatest degree among the plurality of vertices.

11. The system of claim 9, wherein:
the individual neighboring vertices are repositioned by a distance that is based at least in part on a ratio of the distance between the first clipped vertex and the nearest point on the surface, and
the individual neighboring vertices are repositioned in a same direction as the repositioning of the first clipped vertex.

12. The system of claim 11, wherein the ratio is based at least in part on a distance of the individual neighboring vertices from the first clipped vertex.

13. The system of claim 9, wherein the instructions, when executed by the one or more processors, further cause performance of determining whether the plurality of vertices comprises one or more additional clipped vertices.

14. The system of claim 13, wherein the instructions, when executed by the one or more processors, further cause performance of, in response to determining that the plurality of vertices comprises the one or more additional clipped vertices, identifying a second clipped vertex from the plurality of vertices that is clipped into a surface of the convex hull to a greatest degree among the plurality of vertices.

15. A non-transitory, computer-readable medium embodying program instructions stored in a memory of a computing device that, when executed by a processor of the computing device, cause the computing device to at least:
decompose a mesh of a three-dimensional digital object into a first sub-mesh and a second sub-mesh;
identify one or more vertices from the first sub-mesh and one or more vertices of the second sub-mesh that are symmetrical;
determine a symmetry plane for the first sub-mesh and the second sub-mesh based at least in part on the one or more vertices of the first sub-mesh and the one or more vertices of the second sub-mesh;
enforce a symmetry between the first sub-mesh and the second sub-mesh based at least in part on the symmetry plane; and
recombine the first sub-mesh and the second sub-mesh into a symmetrized mesh of the three-dimensional digital object.

16. The non-transitory, computer-readable medium of claim 15, wherein the program instructions further cause the computing device to at least:
identify a first portion of the three-dimensional digital object corresponding to the first sub-mesh and a second portion of the three-dimensional digital object corresponding to the second sub-mesh based at least in part on a UV map corresponding to a texture of the three-dimensional digital object and the mesh of the three-dimensional digital object, and
wherein the first portion of the three-dimensional digital object and the second portion of the three-dimensional digital object are symmetrical.

17. The non-transitory, computer-readable medium of claim 16, wherein the program instructions causing the computing device to identify the first portion of the three-dimensional digital object and the second portion of the three-dimensional digital object based at least in part on the UV map further cause the computing device to at least:
identify a first portion of the texture of the three-dimensional digital object that comprises one or more particular characteristics; and
identify a second portion of the texture of the three-dimensional digital object that comprises the one or more particular characteristics.

18. The non-transitory, computer-readable medium of claim 15, wherein the symmetry plane comprises an XY plane, an XZ plane, or a YZ plane.

19. The non-transitory, computer-readable medium of claim 15, wherein the program instructions that cause the computing device to determine the symmetry plane for the first sub-mesh and the second sub-mesh further cause the computing device to at least:
identify an axis of symmetry between the one or more vertices of the first sub-mesh and the one or more vertices of the second sub-mesh;
identify a normal vector to the symmetry plane that aligns with the axis of symmetry;
identify a midpoint between the one or more vertices of the first sub-mesh and the one or more vertices of the second sub-mesh; and
identify the symmetry plane based at least in part on the normal vector and the midpoint.

20. The non-transitory, computer-readable medium of claim 15, wherein the program instructions further cause the computing device to at least identify one or more duplicate symmetry planes based at least in part on a normal vector to the symmetry plane.
